(19) United States
(12) Patent Application Publication
(10) Pub. No.: US 2006/0080522 A1
(43) Pub. Date: Apr. 13, 2006

(54) Method, apparatus, and system for facilitating secure computing

(76) Inventors: Russell Edward Button, Alameda, CA (US); Michael Thomas Gracy, Concord, CA (US)

Correspondence Address: COOLEY GODWARD, LLP, 3000 EL CAMINO REAL, 5 PALO ALTO SQUARE, PALO ALTO, CA, 94306, US

(21) Appl. No.: 11/241,583

(22) Filed: Sep. 30, 2005

Related U.S. Application Data
(60) Provisional application No. 60/618,088, filed on Oct. 13, 2004.

(51) Int. Cl. G06F 15/177

(52) U.S. Cl. 713/2

(57) ABSTRACT

A method, apparatus, and system are described for facilitating secure computing. A method of booting a computer invokes a program contained in a read-only memory on power-up of the computer, where the program contains at least a minimal operating system, then searches for at least an additional operating system program necessary to complete the booting of the computer. The additional operating system program is read-only, or is modifiable only by an updated program contained in a server accessible to the computer. The booting of the computer is halted if the additional operating system program is not accessible to the computer. The booting of the computer proceeds if the additional operating system program is accessible to the computer. One embodiment of the invention is a computer system containing at least a processor, a first read/write memory coupled to the processor, a boot medium coupled to the processor, and an attachment interface coupled to the processor, where the attachment interface is for accessing a secondary boot medium for the computer system. The boot medium is for initiating a boot sequence of the computer system, and contains at least a read-only memory containing a minimal operating system.

### CROSS REFERENCE TO RELATED APPLICATIONS

This application claims the benefit of U.S. Provisional Application No. 60/618,088, entitled “Computing Device with Bootable Flash Disk,” filed on Oct. 13, 2004, the disclosure of which is incorporated herein by reference in its entirety.

### FIELD OF THE INVENTION

The present invention relates generally to computer systems that facilitate secure computing. More particularly, embodiments of the invention relate to a computer system with at least one bootable read-only device that can be securely operated in a network computing environment.

### BACKGROUND OF THE INVENTION

Traditional desktop computers (e.g., PC, Macintosh, UNIX workstation, etc.) generally store system software on data storage devices that are capable of both read and write operations to enable updates of that software. An undesirable side effect is that when a malicious attacker gains access to a computer, system binaries and files can be altered as the attacker desires, potentially compromising the computer. Similar problems can also occur when an authorized user alters system binaries or files unintentionally. In a network of computers, the risk multiplies from attackers or untrained users, as the entire network may be damaged from a single compromised computer.

Traditional UNIX and UNIX-related operating systems, for example, have programmer tools that can be exploited by an attacker. One attempt to address these vulnerabilities is a bootable compact disc (CD) distribution of Linux called Knoppix, developed by Knopper.Net of Germany. Because the CD used for this distribution is a read-only device, even if a malicious attacker gains access to the machine, system binaries and files cannot be altered.

Use of existing read-only bootable media, however, can give a user administrative access to modify system binaries and files stored on locally accessible data storage devices such as hard disks, and thus the ability to readily attack other network devices (e.g., computers, routers, load balancers, etc.) on the network. The same risk results from virtual machines that can be started from software contained in portable storage such as universal serial bus (USB) based flash drives. A user may also use administrative access to modify user application binaries and files, potentially with the same damaging effects to the network. Accordingly, it would be desirable to provide a system that includes the advantages of booting from a read-only device, and that reduces the network security risks tied to user behavior.

At the same time, since a typical corporate network environment has a 125:1 ratio of desktop computer users to support technicians, the efficiency of the update process for user desktop software is important. A common software update mechanism is to remotely and automatically update user desktop computers from a central computer not accessible to users. This mechanism eliminates the need for a support technician to physically update each user desktop computer, but depends on user desktop software being modifiable rather than read-only, which creates a network security risk. Accordingly, it would be desirable to provide a system that includes the advantages of remote software updates of user desktop computers while retaining the inherent security of booting from a read-only device.

### SUMMARY OF THE INVENTION

A method, apparatus, and system are described for facilitating secure computing. A method of booting a computer comprises: invoking a program contained in a read-only memory on power-up of the computer, where the program comprises a minimal operating system; searching for an additional operating system program necessary to complete the booting of the computer, where the additional operating system program is read-only, or is modifiable only by an updated program contained in a server accessible to the computer; and halting the booting of the computer if the additional operating system program is not accessible to the computer, or proceeding with the booting of the computer if the additional operating system program is accessible to the computer. The additional operating system program may be authenticated based on authentication identifiers received from the server.

One embodiment of the invention is a computer system comprising: a processor; a first read/write memory coupled to the processor; a boot medium coupled to the processor, where the boot medium comprises a read-only memory containing a minimal operating system, and where the boot medium is for initiating a boot sequence of the computer system; and an attachment interface coupled to the processor, where the attachment interface is for accessing a secondary boot medium for the computer system. The computer system may be a client computer system, or may be executing a server program. The read-only memory may be a solid-state memory. The first read/write memory coupled to the processor may contain an emulated hard disk. The secondary boot medium may be a second read/write memory, such as a solid-state memory, that comprises an additional operating system program required for completion of the boot sequence. The secondary boot medium may alternatively be a second read-only memory that comprises an additional operating system program required for completion of the boot sequence. A user storage medium may be coupled to the processor, where the user storage medium comprises a third read/write memory for storing files that cannot be stored on the computer system.

### BRIEF DESCRIPTION OF THE DRAWINGS

For a better understanding of the nature and objects of the invention, reference should be made to the following detailed description taken in conjunction with the accompanying drawings, in which:

FIG. 1 illustrates a logical block diagram of a computer and media potentially coupled to the computer, in accordance with one embodiment of the present invention;

FIG. 2 illustrates a logical block diagram of a computer network containing clients and servers, in accordance with one embodiment of the present invention;

FIG. 3 illustrates a flowchart of a process for booting a client computer including interactions with a secondary boot medium and a naming server, in accordance with one embodiment of the present invention;

FIG. 4 illustrates a detailed flowchart of a process for finding information on and preparing access to a secondary boot medium within a process for booting a client computer, in accordance with one embodiment of the present invention; and

FIG. 5 illustrates a detailed flowchart of a process for update and authentication of a secondary boot medium within a process for booting a client computer, in accordance with one embodiment of the present invention.

### DETAILED DESCRIPTION OF THE INVENTION

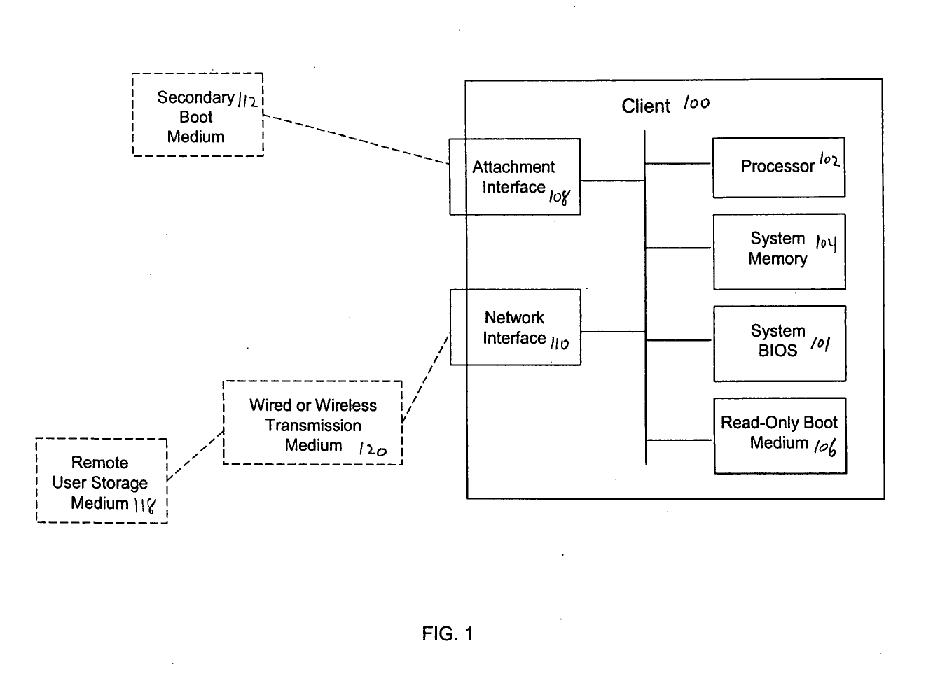

FIG. 1 illustrates a logical block diagram of a client computer and media potentially coupled to the client computer, in accordance with one embodiment of the present invention. A client 100 is an integrated computing system involving a desktop, floor-standing, or portable workstation that processes information to achieve a desired result. The client 100 comprises a processor 102 that may be a central processing unit commonly used in PCs such as an Intel Pentium 4, and the following components coupled to the processor 102: system memory 104 that may be volatile or non-volatile, a system BIOS 101, a read-only boot medium 106, one or more attachment interfaces 108, and one or more network interfaces 110. The processor 102, the system memory 104, and the system BIOS 101 are standard components on conventional computer motherboards. The read-only boot medium 106 can plug into a motherboard expansion slot. According to one or more embodiments of the invention, the client 100 can be employed with a variety of operating systems (OS), such as UNIX, Linux, BSD, Solaris, BeOS, or any other suitable, similar, or related OSs.

As described below in more detail, the client 100 invokes a minimal OS contained in the read-only boot medium 106 to initiate the boot process of the client 100. Additional software required for completion of the boot process and for user operation of the client 100, comprising an additional OS software program and potentially user applications, is contained on a secondary boot medium 112. The boot process halts if the secondary boot medium 112 is not accessible to the client 100. In one embodiment, one of the attachment interfaces 108 is a hardware interface used to couple the secondary boot medium 112 to the processor 102. The secondary boot medium 112 may be read-only, which minimizes network security risk due to modification of system binaries and files but which is not remotely updatable. The secondary boot medium 112 may be read/write, which allows for remote updates following a secure process described below in more detail. The secondary boot medium 112 may be internal to the client 100 or external to the client 100, and may be removable.

The read-only boot medium 106 is a read-only memory that according to one or more embodiments of the invention is a bootable, physically read-only solid-state memory device. The read-only boot medium 106 can be used to store software required for the client 100 to boot. Because the read-only boot medium 106 is physically incapable of being written to, installation of additional software for the booting process is not possible. The read-only boot medium 106 is typically not serviceable by the end user. Suitable attachment interfaces 108 include an integrated drive electronics (IDE) interface, an AT attachment (ATA) interface, a serial ATA interface, or a SCSI interface. The secondary boot medium 112 may be a standard read/write solid-state memory device, a bootable read-only solid-state memory device, a CD-ROM, or a DVD-ROM. Possible solid-state memory devices include but are not limited to an IDE or SCSI flash disk.

In one embodiment, the client 100 does not contain a hard disk. The client 100 is thus dependent on the secondary boot medium 112 for all additional software required to complete the boot process to operate the client 100 that is not contained on the read-only boot medium 106. The client 100 may be coupled to a remote user storage medium 118 via a wired or wireless transmission medium 120 for storage of user files generated by the client 100.

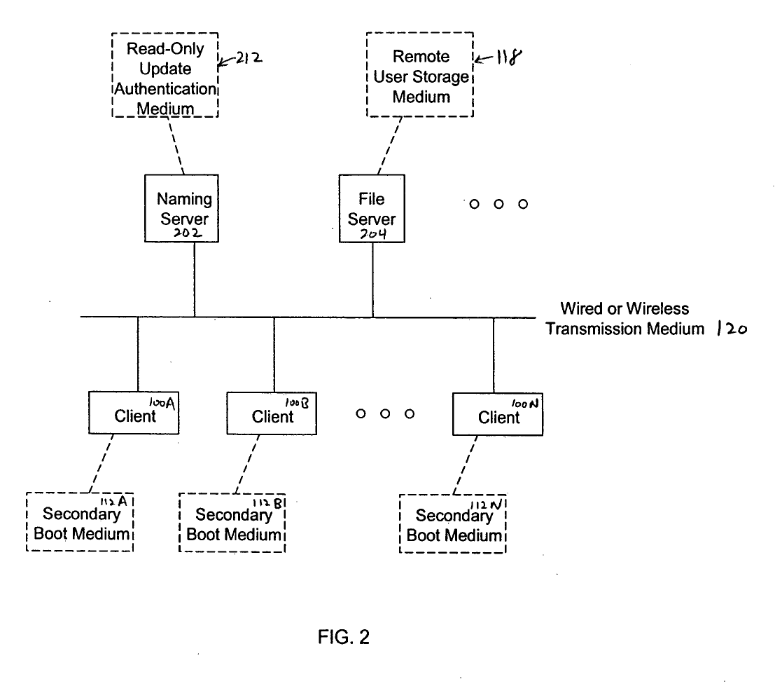

FIG. 2 illustrates a logical block diagram of a computer network containing one or more clients 100A-100N and one or more servers, in accordance with one embodiment of the present invention. In one embodiment, the client 100 is a user desktop or portable computer. One or more clients 100 can be dependent on services provided by a network-based naming server 202, a network-based file server 204, and other servers. The naming server 202 and the file server 204 are one or more computers that provide services to clients 100. A single computer can act as both the naming server 202 and the file server 204. Conversely, multiple computers, possibly in a fail-over cluster, can act as the naming server 202, or as the file server 204. The clients 100 are coupled to each other, to the naming server 202, and to the file server 204 via a wired or wireless transmission medium 120 that can serve as a computer network.

The naming server 202 and the file server 204 may be a computer containing the same components shown in FIG. 1 as part of client 100, or may be a conventional computer. In particular, the naming server 202 and the file server 204 may boot conventionally, such as from system BIOS 101 and a hard disk, and do not require a read-only boot medium 106 nor a secondary boot medium 112.

The naming server 202 can provide to clients 100, for example, configuration information, such as user account information, user/host authentication, location of user home directories, domain name system (DNS) services (e.g., host IP address resolution), and/or printer information, as well as any other configuration information desired. Network services can be provided and/or managed by the naming server 202 using an appropriate protocol, such as the lightweight directory access protocol (LDAP) for distributing user account information, user and host authentication, user home directory location, and printer configuration. Other services provided by the naming server 202 include DNS services for providing host internet protocol (IP) information, dynamic host configuration protocol (DHCP) services, print spooling, and other services. Using the naming server 202 can be advantageous in some cases because it can eliminate the possibility of human error while installing computers on a network. Additionally, using the naming server 202 can eliminate the requirement of a computer installation technician during computer installation (thereby potentially reducing costs associated with installation). Moreover, using the naming server 202 can enable the client 100 to use read-only devices for system and application software with all of the attendant advantages, as described above. Additionally, the use of the naming server 202 in combination with the use of read-only devices, as described above, can provide safe operation of the client 100 in a restricted user environment.

The file server 204 enables clients 100 to store user files generated by clients 100 on the remote user storage medium 118. Embodiments of the remote storage medium 118 include network attached storage (NAS) accessed via the network interface 110 of the file server 204, and a hard disk accessed via a serial ATA embodiment of the attachment interface 108 of the file server 204. User data can be stored and accessed from Samba network file storage, a well known and widely used practice in UNIX networks. User data is secured by configuring the file server 204 to authenticate the user. Using the file server 204 for storage of user data can be advantageous in some cases because it eliminates the need for a local hard disk at each client 100, as well as eliminating the need to backup data from individual workstations.

In one embodiment, all clients 100 in a working network environment have an identical software configuration. The software included with the client 100 comprises an operating system with supporting libraries and utilities, custom utilities to handle special services such as secure updating of operating system software, common user applications such as word processing software and web browsing software, common user interface applications such as graphical user interface software, and client software for services such as LDAP and DNS provided by the naming server 202 and the file server 204. Users of the clients 100 can thus be restricted to using only those programs that are provided with clients 100 on the secondary boot media 112. Additional applications may be distributed to users from the naming server 202 and the file server 204 such as, for example, Framemaker, Autocad, or custom in-house written applications. To facilitate network security, the client 100 may not run any services that could be accessed remotely, such as sshd, telnetd, or ftpd. In the preferred embodiment, the clients 100 do not contain a hard disk, and are dependent on the secondary boot medium 112 for all additional software required to complete the boot process to operate the client 100 that is not contained on the read-only boot medium 106. Because there is nothing to configure on clients 100, each client 100 becomes a simple productivity tool that is as easy to install as a simple electrical appliance such as a lamp.

The software components contained in each secondary boot medium 112 may be updated by each client 100 using software downloaded from the naming server 202. The naming server 202 will either store these software components on disk storage local to it, or optionally on NAS such as would be available on the file server 204. The naming server 202 has a read-only update authentication medium 212 which contains unique authentication identifiers used by the client 100 to validate the software components needed for the update of the secondary boot medium 112. The read-only update authentication medium 212 may also contain the software components needed for the update of the secondary boot medium 112. These authentication identifiers are the basis for the secure updating process of the secondary boot medium 112 used by each client 100, and therefore should not themselves be dependent on network security mechanisms.

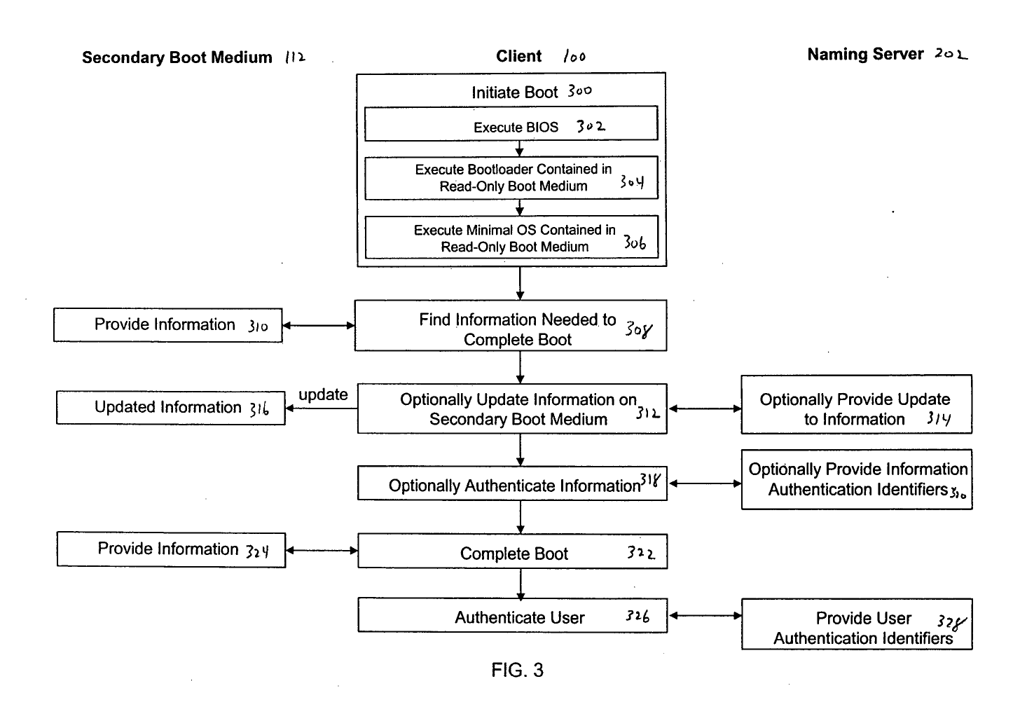

FIG. 3 illustrates a flowchart of a process for booting a client 100 including interactions with a secondary boot medium 112 and a naming server 202, in accordance with one embodiment of the present invention. The client 100 first initiates the boot process in step 300 by invoking the standard system BIOS 101. The functions of the BIOS program include power-on self-test (POST), comprising memory test, verification that the necessary hardware is present, and inventory of the system configuration; discovery of the boot device, in this case the read-only boot medium 106, and loading of the master boot record (MBR) into system memory 104, where the MBR is the first data sector of the read-only boot medium 106; and transfer of control to the bootloader, the program at the beginning of this first data sector. The system BIOS 101 is simply the standard BIOS that every motherboard manufacturer provides. In step 304, the bootloader contained in read-only boot medium 106 is executed from system memory 104. The bootloader then loads and transfers control to the minimal OS, which contains the OS kernel. The minimal OS may also contain a startup script (in the case of Linux, this is called “linuxrc”), device drivers, and system utilities. In step 306, the OS kernel executes. The function of the OS kernel is to manage system resources such as system random access memory (RAM), CPU time, storage devices, network devices, input/output devices and peripherals. When the OS kernel first executes, it initializes system devices compiled into it and other system resources. It then passes control to a startup script, which initializes more system devices, file system support, creates a RAM disk and copies into the RAM disk essential system utilities. The startup script initializes the network interface 110.

In step 308, the minimal OS searches for information needed to complete the boot process. In one embodiment, the minimal OS searches for an accessible secondary boot medium 112. The minimal OS may search for an attachment interface 108, and for a secondary boot medium 112 of the proper type, such as an IDE, serial ATA, or SCSI solid-state memory device. The minimal OS may then search for files on the secondary boot medium 112, such as cloop files. These files enable the referencing of other files, such as files in cloop file systems, on the secondary boot medium 112 as though the secondary boot medium were a block device such as a hard drive. If any of the above are not found, the minimal OS may halt the booting process and may force a restart of the client 100. If all of the above information is found, the minimal OS receives any necessary information from the secondary boot medium 112 in step 310.

In step 312, the minimal OS may optionally update information on the secondary boot medium 112. In step 314, the minimal OS checks with the naming server 202 whether there is an update to the secondary boot medium 112. If so, in step 316 the minimal OS installs the updated information on the secondary boot medium 112, then proceeds to step 318. If not, the minimal OS proceeds directly to step 318. In step 318, the minimal OS may optionally authenticate selected information on the secondary boot medium 112. If so, the naming server 202 provides authentication identifiers such as checksum values for cloop files in step 320. To ensure a secure update process, the naming server 202 obtains these authentication identifiers from the read-only update authentication medium 212. After authentication, the association of files on the secondary boot medium 112 to a logical directory on the client 100, known as mounting of file systems on the secondary boot medium 112, may take place. In step 322, the boot process is then completed as all additional OS programs and any user applications are obtained from the secondary boot medium 112 in step 324. Since the secondary boot medium 112 may be a relatively slow flash medium, at least a portion of the user application software may be loaded into a RAM disk and executed from the RAM disk. For example, a common web browser such as Mozilla can take several times longer to start up when loaded from standard flash media than when loaded from a RAM disk. At this point the full OS takes control of client 100. In step 326, the user is then authenticated based on user authentication identifiers obtained from the naming server 202 in step 328. If this authentication succeeds, then the user can use the functionality of the client 100 available to this user. If not, the user is denied access.

In an embodiment where the naming server 202 uses a conventional booting process, the conventional booting process completes independently of the accessibility of the read-only update authentication medium 212.

A system according to one or more embodiments of the invention can prevent a user from executing system and application software that a system administrator or other entity does not want the user to execute. For example, the system can prevent a user from executing system and application software that is not recognized as being provided by a system administrator, a technical staff associated with the system, or other interested entities. As such, the execution of malicious software can be substantially curtailed or prevented entirely. Additionally, installation and use of unlicensed software can also be substantially curtailed or prevented entirely.

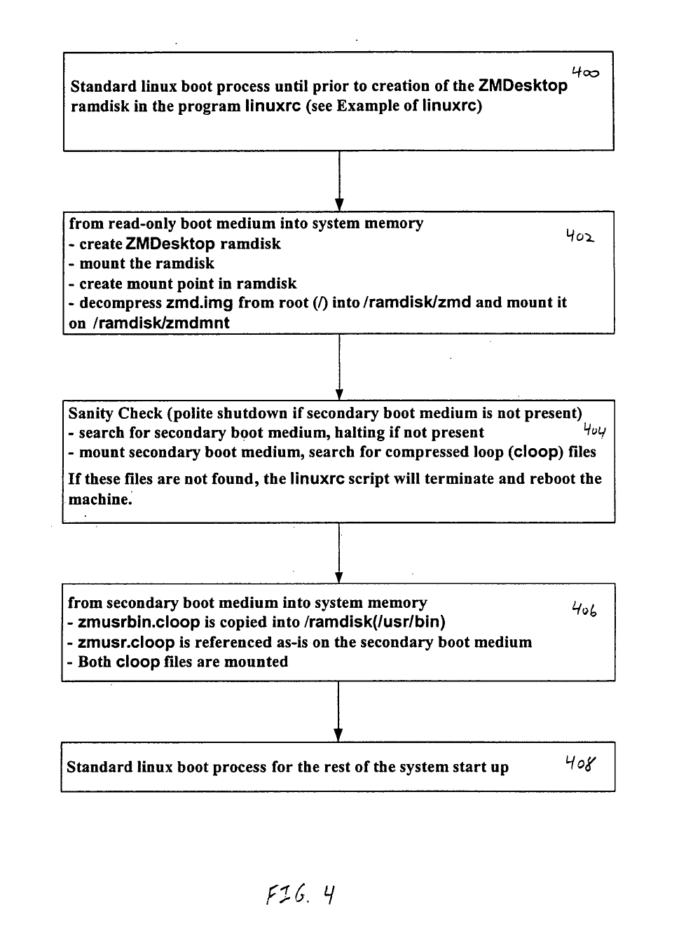

FIG. 4 illustrates a detailed flowchart of a process for finding information on and preparing access to a secondary boot medium 112 within a process for booting a client 100, in accordance with one embodiment of the present invention. The process in FIG. 4 is described in connection with the boot process example given below. The boot process example is given with respect to an embodiment of the invention employed for a computing device using a Linux OS. Boot processes for other OSs according to one or more other embodiments of the invention are similar to the example described below with changes required or desired for proper operation in those other OSs.

Boot Process Example for Linux

Below, several operations are described that can be performed during a boot process of a computing device using a Linux or Linux-related OS. These operations are intended as examples only, and can be modified for use with different operating systems, or as desired for different performance. For example, the order and/or substance of the various example operations described below can be changed as needed or desired. The example process described below is related to the process shown in FIG. 4. This process is broken up into sections for purposes of the description below.

In step 400, the first section of the process is the initial phase of the standard Linux boot process, an example of which is shown below. This section of the process includes the execution of the BIOS and bootloader programs.
Power-On
MBR read
GRUB bootloader (stage 1) from disk under hd(0,0)/boot/grub
GRUB bootloader (stage 2) from disk under hd(0,0)/boot/grub
GRUB menu is pulled in from hd(0,0)/boot/grub/grub.conf (see grub.conf example below)
   boot selection can be defaulted, edited, or left to time out

After the initial phase, a kernel section of the process takes place, an example of which is described below.
kernel (vmlinuz) loads
   kernel allocates 8 MB ramdisk
   kernel decompresses initrd.img into ramdisk, creating a temporary root file system
   kernel executes /linuxrc which prepares the rest of the boot process

After the kernel section of the process, a linuxrc section of the process takes place, an example of which is described below.
linuxrc (see linuxrc example below)
   loads kernel module for ext3 file system
   calls linuxrc.nash with nash to establish devices, and to mount a real root file system (disk on chip) and pivot it into place (see linuxrc.nash example below)
      (At this point in linuxrc, step 402 starts. The purpose of step 402 is to create and mount the RAM disk.)
create ZMDesktop ramdisk
mount the ramdisk to /ramdisk
create /ramdisk/zmdmnt
decompress zmd.img from root (/) into /ramdisk/zmd and mount it on /ramdisk/zmdmnt
   (At this point in linuxrc, step 404 starts. The purpose of step 404 is to search for the secondary boot medium 112, halting the boot process if the secondary boot medium 112 is not found, then to search for cloop files on the secondary boot medium 112. If the cloop files are not found, the boot process is again halted.)
search for DVD-ROM drive and media, halting if either is not present
mount DVD, search for compressed loop (cloop) files “zmusr.cloop” and “zmusrbin.cloop”. If these files are not found, the linuxrc script will terminate and reboot the machine.
   (At this point in linuxrc, step 406 starts. The purpose of step 406 is to load and mount the cloop files so that the system and application software on the secondary boot medium 112 can be efficiently executed. In this embodiment, zmusrbin.cloop corresponds to software that is copied to the RAM disk, and zmusr.cloop corresponds to software that remains on the secondary boot medium 112.)
once the files are found, zmusrbin.cloop is copied into /ramdisk(/usr/bin).
zmusr.cloop is referenced as-is on the DVD.
Both cloop files are mounted using losetup and mount:
   losetup /dev/cloop /mnt/cdrom/zmusr.cloop
   mount -r /dev/cloop /usr 2>/dev/null
      (From this point forward in linuxrc, the standard Linux boot process continues in step 408.)
Any needed cleanup and error checking is performed, and control of the boot process is handed off to init(8).

After the linuxrc section of the process, an init section takes place, an example of which is described below.
init
   runs /etc/rc.d/rc.sysinit
      checks root file system and insures the system is stable
      only deviation from stock rc.sysinit is mounting root read-only just prior to the fsck in order to keep the fsck from failing (this appears to have been mitigated by running fsck on the disk-on-chip).
   Enters runlevel 5
      Runs all ‘K’ scripts in /etc/rc5.d with a ‘stop’ argument
      Runs alld ‘S’ scripts in /etc/rc5.d with a ‘start’ argument
      X starts
      User is presented with login screen
      [Default session is KDE]
         Example of grub.conf from /boot/grub

Below is an example of grub.conf from /boot/grub as referenced above in the boot process example for Linux. The example shown below is merely one example of grub.conf.

```
# grub.conf generated by anaconda
#
# Note that you do not have to rerun grub after making changes to this file
# NOTICE: You have a /boot partition. This means that
# all kernel and initrd paths are relative to /boot/, eg.
# root (hd0,0)
# kernel /vmlinuz-version ro root=/dev/sda2
# initrd /initrd-version.img
#boot=/dev/sda
default=0
timeout=90
#splashimage=(hd0,0)/grub/splash.xpm.gz
title Fedora Core (2.4.22-1.2115.nptl)
    root (hd0,0)
    kernel /boot/vmlinuz-2.4.22-1.2115.nptl ro root=LABEL=/ rhgb
    initrd /boot/initrd-2.4.22-1.2115.nptl-zmdesktop.img
```

Example of linuxrc from initrd-2.4.22-1.2115.nptl-zmdesktop.img

Below is an example of linuxrc from initrd-2.4.22-1.2115.nptl-zmdesktop.img, as referenced above in the boot process example for Linux. The example shown below is merely one example of linuxrc.

```
#!/bin/bash
PATH=/bin:/sbin:/
# Clean input/output
mknod /dev/console c 5 1
exec >/dev/console </dev/console 2>&1
echo “Loading scsi_mod.o module”
insmod /lib/scsi_mod.o
echo “Loading Sd_mod.o module”
insmod /lib/sd_mod.o
echo “Loading BusLogic.o module”
insmod /lib/BusLogic.o
echo “Loading jbd.o module”
insmod /lib/jbd.o
echo “Loading ext3.o module”
insmod /lib/ext3.o
echo Calling Nash
nash --force /linuxrc.nash
# We should have regular root from /dev/<bootdevice> as pivoted by
pivot_root.
# Mount proc proper
/bin/mount −t proc proc /proc
# Mount the ramdisk now
echo Mounting ramdisk
/bin/mount −t tmpfs −o rw,size=400000k ramdisk /ramdisk
#echo Copying zmd image
#cp /zmd.img /ramdisk
mkdir /ramdisk/zmdmnt
cd /ramdisk
echo Decompressing/Installing zmd image
#gzip −dS .img zmd.img
gzip −dcS .img /zmd > zmd
echo Mounting zmd image
mount /ramdisk/zmd /ramdisk/zmdmnt −o loop
echo Making home dir
mkdir /ramdisk/home
chmod 755 /ramdisk/home
echo “”
# Finding the cdrom drive.
devs=‘/bin/ls /proc/ide | grep hd‘
for d in $devs; do {
  grep −q cdrom /proc/ide/$d/media && {
    cdrom=$d;
    break;
  };
} done;
if [ −z “$cdrom” ]; then {
  echo “No CD-ROM device found; aborting.” >&2;
  exit 42;
} fi;
if [ $? −ne 0 ]; then {
  echo “Contact your systems administrator or help desk!”;
}
else {
  echo “Mounting and looking for ZMDesktop Apps disc.”;
  mount /dev/$cdrom /mnt/cdrom −o ro;
} fi;
(/sbin/insmod cloop 2>&1 && echo “Cloop kernel module loaded.”) ∥
{
  echo “Cloop kernel module failed to load.”
  echo “Contact you systems administrator or help desk!”
  echo “Press Enter to continue....”
  read keypress;
  shutdown −h now
}
# Looking for and mounting the cloop images.
if [ −f /mnt/cdrom/zmusr.cloop ]; then
  losetup /dev/cloop /mnt/cdrom/zmusr.cloop
  mount −r /dev/cloop /usr 2>/dev/null
else
  echo “Failed to find zmusr.cloop, halting the system”
  shutdown −h now
fi
if [ −f /mnt/cdrom/zmusrbin.cloop ]; then
  cp /mnt/cdrom/zmusrbin.cloop /ramdisk/
  losetup /dev/cloop1 /ramdisk/zmusrbin.cloop
  mount −r /dev/cloop1 /usr/bin 2>/dev/null
  xv=$?
else
ech o “Failed to find zmusrbin.cloop, halting system”
  shutdown −h now
fi
if [ $xv = 0 ]; then
  echo It all looks good from here
else
  echo There is a serious problem!
  echo “”
  printf “Press Enter to (try to) continue booting: ”
  read x
fi
exit
```

Example of linuxrc.nash from initrd-2.4.22-1.2115.nptl-zmdesktop.img

Below is an example of linuxrc.nash from initrd-2.4.22-1.2115.nptl-zmdesktop.img, as referenced above in the boot process example for Linux. The example shown below is merely one example of linuxrc.

# Mount proc
echo Mounting proc filesystem
mount −t proc /proc /proc
echo Creating block devices
mkdevices /dev
echo Creating root device
mkrootdev /dev/root
# Tell system where root currently is.
echo 0x0100 > /proc/sys/kernel/real-root-dev
echo Mounting root filesystem
/bin/mount −n −o rw −t ext3 /dev/root /sysroot
# Moved the pivot_root command here to facilitate using the existing
commands
echo pivoting root fs
pivot_root /sysroot /sysroot/initrd
echo Unmounting initrd proc filesystem
/bin/umount /initrd/proc

Creation of ZMDesktop

A copy of the disckonchip can be made by creating the copy as a primary device on a hardware interface associated with a client 100. For example, using an IDE hardware interface, the copy can be placed on idechannel 0 by itself. The client 100 can then boot off of the primary device, then do a dd (data dump, a byte-for-byte copy from one device to another) on itself with a bs (block size) of 512.

To make a cloop image, an iso (single file generated from a filesystem) of a filesystem can be made and passed through the ‘create_compressed_fs’ program. The resulting file is a cloop image mountable on a /dev/cloop? entry.

To make the dvd, all of the cloop files should be gathered and placed in single directory. An iso can then be made of the cloop files. Various flags can be provided by way of a mkisofs (make iso) manual page for descriptions of the various flags. For example, a −P can be a superfluous flag that is not required for proper operation. The −V flag, on the other hand, gives the ‘volume label’ on the iso/cd and is a good idea.

Below is an example of a command that can be used to make a cloop image file.
mkisofs -exclude-list exclude.list -iso-level 4 -allow-lowercase -r -no-rr -U -D -V “_usr” -P “mike@supportemail.com” -hide-rr-moved -no-cache-inodes -no-bak -pad /usr | nice -5 ./create_compressed_fs - 65536 >./zmusr.cloop

In the above example, in addition to normal settings for such a situation, an extra option (-exclude-list) is used to ignore files and/or directories. An example of exclude.list can be: /usr/bin/*. According to one or more embodiments of the invention, two distinct cloop files are created. The first contains only /usr/bin/* and the second everything else except /usr/bin, and is formed using the exclude list.

To create the cloop file, according to an embodiment of the invention, a copy of cloop2.00.tar.gz can be used, and the contents of that file can be compiled to create one object file and two binary files. A kernel module (cloop.o) is copied to /lib/modules/<kernel version>/kernel/drivers/block so that it may be loaded with insmod during boot (via linuxrc). Other binaries can be used to create and to extract to and from cloop files. For example, a cloop file that might be used in accordance with an embodiment of the invention is a ‘create_compressed_fs’. An example of how that file is used is described above.

According to one or more embodiments of the invention, mknod can be used to create two /dev/cloop devices to mount two cloop files. Information about this can be contained in a “readme” file included with source code for the major and minor node numbers, for example. The following cloop files can be made /dev/cloop and /dev/cloop1. Of course, any naming convention for these files is suitable if other adjustments to the relevant source code are made, for example, by changing the linuxrc (initrd) to follow the file naming convention.

According to one or more embodiments of the invention, the dvd for containing the cloop files can be made using the following command, for example:
mkisofs -no-pad -iso-level 3 -l -r -v -V “ZMDESKTOP_APPS” -hide-rr-moved -o ./zmdapps.iso /appsiso/

Once the above operation has been performed, the iso can be burned to disk with any suitable burning technique.

An image that is ready for writing to a diskonchip (e.g., minus bootsector/grub installation) can be made using the following operations, which create the same directory structure.

/boot/*
/etc/*(only put needed files for boot here)
/dev/*(fully populate for now)
/usr/*(this will be an empty mnt point for the cloop file zmusr.cloop
from cd)
/home(symlink into /ramdisk/home)
/ramdisk(empty mnt point for the 400MB ramdisk)
/tmp/*(symlinks back to the files in /ramdisk/zmdmnt/tmp)
/var/*(symlinks back to the files in /ramdisk/zmdmnt/var)
/mnt/*(include /mnt/cdrom for the linuxrc to work)

According to one or more embodiments of the invention, a CD can be created from the tree above that would contain all the needed or desired files and/or symlinks, and other structures. Such a CD can be bootable, for example, and can include a script of a questionnaire that asks to perform an installation operation. Upon performing the installation operations, the CD can format and copy and/or uncompress the file structure into place. The operation can then perform the grub installation.

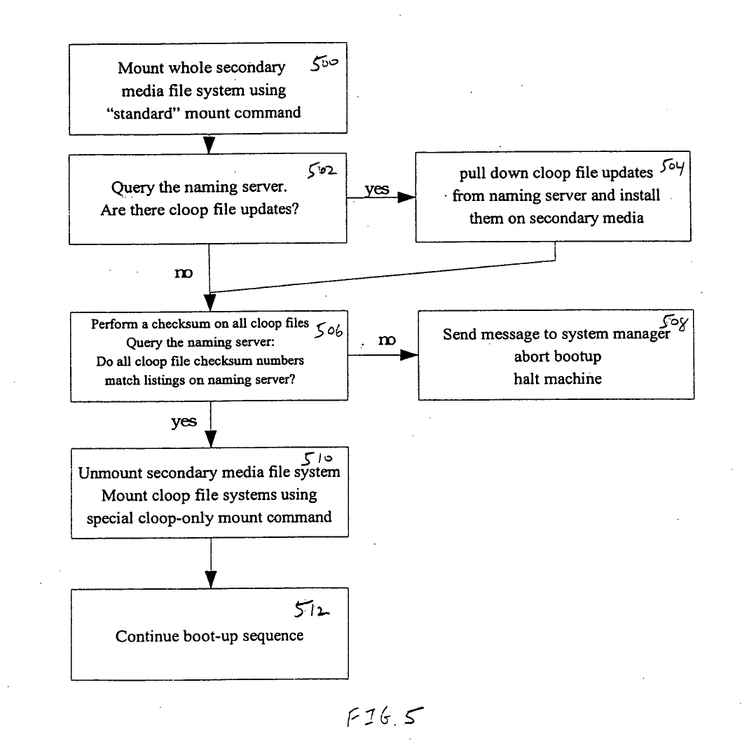

FIG. 5 illustrates a detailed flowchart of a process for update and authentication of a secondary boot medium 112 within a process for booting a client 100, in accordance with one embodiment of the present invention. This example is again given with respect to an embodiment of the invention employed for a computing device using a Linux OS. Boot processes for other OSs according to one or more other embodiments of the invention are similar to the example described below with changes required or desired for proper operation in those other OSs. The steps described in FIG. 5 are in addition to steps 404 and 406 in FIG. 4. On bootup, the minimal OS running on the client 100, as shown in step 500, uses the standard mount command to mount the whole file system of the secondary boot medium 112. In step 502, the minimal OS then queries the naming server 202 for cloop file updates. If found, in step 504 the cloop file updates are downloaded from the naming server 202 and installed on the secondary boot medium 112 before proceeding to step 506. If not, the minimal OS proceeds directly to step 506. In step 506, the minimal OS performs a checksum on the cloop files and compares the checksum values to values from the naming server 202. The values from the naming server 202 are from the read-only update authentication medium 212, and are therefore secure. If the checksum values do not match the values from the naming server 202, the boot process is halted in step 508. If the checksum values match the values from the naming server 202, the minimal OS proceeds in step 510 to unmount the file system of the secondary boot medium 112, then to mount the cloop file systems using a special cloop-specific mount command which can only mount cloop filesystems as read-only. The standard Linux boot sequence then continues in step 512.

One benefit of the present invention is that it may be used to make clients 100 more secure. Because the boot file system is read-only or controlled by a secure update process, the ability of intruders to install malicious or altered software on the client 100 is reduced or eliminated. To protect against corruption or alteration of the system and application programs on the secondary boot media 112, the file systems of the secondary boot media 112 are validated using comparisons to authentication identifiers obtained by the naming server 202 from the read-only update authentication medium 212. Users are not able to reboot clients 100 off of their own bootable CDs, and are not able to run their own executable programs. Another benefit of the present invention is that it may be used to remotely update the secondary boot media 112 of clients 100 while retaining the inherent security of booting completely from read-only devices. Updates can be used to quickly and conveniently distribute new application features from a central naming server 202 and/or file server 204. Another benefit of the present invention is that installation of clients 100 is facilitated. Since the clients 100 are hard-coded to obtain any information that it needs from servers 202 and 204, there is no installation configuration effort needed to install the clients 100.

From the foregoing, it can be seen that a method, apparatus, and system for facilitating secure computing are described. The foregoing description, for purposes of explanation, used specific nomenclature to provide a thorough understanding of the invention. Specific embodiments have been described above in connection with computers using bootable read-only and secondary boot devices in connection with the Linux operating system. It will be appreciated, however, that embodiments of the invention can be in other specific forms without departing from the spirit or essential characteristics thereof. The described embodiments are not intended to be exhaustive or to limit the invention to the precise forms disclosed; obviously, many modifications and variations are possible in view of the above teachings. For example, while some embodiments have been described in the context of the Linux operating system, the invention can be employed in a variety of different configurations from the examples described above, which can be employed with a variety of operating systems. The presently disclosed embodiments are, therefore, considered in all respects to be illustrative and not restrictive. The embodiments were chosen and described in order to best explain the principles of the invention and its practical applications; they thereby enable others skilled in the art to best utilize the invention and various embodiments with various modifications as are suited to the particular use contemplated. It is intended that the following claims and their equivalents define the scope of the invention.

What is claimed is:

1. A method of booting a computer, said method comprising:
invoking a program contained in a read-only memory on power-up of said computer, said program comprising a minimal operating system;
searching for an additional operating system program necessary to complete said method of booting said computer, wherein said additional operating system program is read-only or modifiable only by an updated program contained in a server accessible to said computer; and
halting said method of booting said computer if said additional operating system program is not accessible to said computer, or proceeding with said method of booting said computer if said additional operating system program is accessible to said computer.

2. The method of claim 1, further comprising:
executing said additional operating system program through emulation.

3. The method of claim 1, further comprising:
performing authentication of said additional operating system program based on authentication identifiers received from said server; and
halting said method of booting said computer if said authentication of said additional operating system program fails, or proceeding with said method of booting said computer if said authentication of said additional operating system program succeeds.

4. The method of claim 3, further comprising:
selectively updating said additional operating system program with said updated program from said server.

5. The method of claim 1, further comprising:
performing authentication of a user of said computer based on at least one identifier received from said user and based on user authentication identifiers received from said server;
denying said user access to said computer if said authentication of a user fails, or allowing said user access to said computer if said authentication of a user succeeds.

6. A computer system comprising:
a processor;
a first read/write memory coupled to said processor;
a boot medium coupled to said processor, said boot medium comprising a first read-only memory containing a minimal operating system, said boot medium for initiating a boot sequence of said computer system; and
an attachment interface coupled to said processor, said attachment interface for accessing a secondary boot medium for said computer system.

7. The computer system of claim 6, further comprising:
a network interface coupled to said processor, said network interface for communicating with a server.

8. The computer system of claim 7, further comprising:
a secondary boot medium coupled to said processor, said secondary boot medium comprising a second read/write memory, said second read/write memory comprising an additional operating system program required for completion of said boot sequence.

9. The computer system of claim 7, further comprising:
a secondary boot medium coupled to said processor, said secondary boot medium comprising a second read-only memory, said second read-only memory comprising an additional operating system program required for completion of said boot sequence.

10. The computer system of claim 8, further comprising:
a user storage medium coupled to said processor, said user storage medium comprising a third read/write memory for storing files that cannot be stored on said computer system.

11. The computer system of claim 8, wherein said boot medium further comprises:
a minimal operating system that halts the booting of said computer system if said secondary boot medium is not accessible to said processor.

12. The computer system of claim 11, wherein:
said first read-only memory is a first solid-state memory; and
said second read/write memory is a solid-state memory.

13. The computer system of claim 12, wherein software contained on said secondary boot medium is modifiable only by an updated program contained in said server.

14. The computer system of claim 13, wherein said first read/write memory coupled to said processor contains an emulated hard disk.

15. A computer system executing a server program, said computer system comprising:
a processor;
a first read/write memory coupled to said processor;
an attachment interface coupled to said processor, said interface for accessing a update authentication medium for said computer system, said update authentication medium comprising a read-only memory; and
a network interface coupled to said processor, said network interface for communicating with a client computer system.

16. The computer system of claim 15, wherein said network interface is responsive to a call from a minimal operating system program executing on another computer system to supply an additional operating system program.

17. The computer system of claim 15, wherein said first read/write memory further comprises user authentication identifiers provided to said client computer system by said server program.

18. The computer system of claim 15, wherein said update authentication medium further comprises software used to update said client computer system.

19. The computer system of claim 15, wherein said update authentication medium further comprises information authentication identifiers provided to said client computer system by said server program.

20. The computer system of claim 15, further comprising:
a user storage medium coupled to said processor, said user storage medium comprising a third read/write memory for storing files that cannot be stored on said client computer system.
